(19) United States
(12) Patent Application Publication
(10) Pub. No.: US 2004/0099369 A1
(43) Pub. Date: May 27, 2004

(54) Composite sheet with mirror finish

(76) Inventors: Darrell L. Sparks, Kennebunk, ME (US); Grant B. LaFontaine, Trumbull, CT (US)

Correspondence Address: KLAUBER & JACKSON, 411 HACKENSACK AVENUE, HACKENSACK, NJ, 07601

(21) Appl. No.: 10/302,754

(22) Filed: Nov. 22, 2002

(51) Int. Cl. B29D 11/00; B32B 31/08; B32B 31/12; B32B 31/30

(52) U.S. Cl. 156/244.24; 359/900; 264/1.9; 156/244.27; 156/278

(57) ABSTRACT

A method for producing a polymer mirror by continuously manufacturing a polymeric substrate, applying a reflective layer or layers which may be a polymer whose surface has been metallized so as to make it reflective or a multilayer film wherein the combined refractive indices of the layers give the quality of a mirror surface. An optional coating may be applied to a surface of the reflective layer to promote adhesion to the underlying substrate. A composite is the formed by heat lamination using a calendar roll assembly to fuse the layers into a rigid final article having a reflective surface having the character of a silver mirror, a highly reflective mirror, or a colored mirror.

### FIELD OF THE INVENTION

This invention relates to a method for producing a polymer-based mirror.

More specifically, the invention relates to a method for producing either a high-reflectance mirror or a colored mirror by laminating a polymeric substrate with a reflective layer or a series of layers.

### BACKGROUND OF THE INVENTION

Most plastic (polymer based) mirrors are produced by vacuum metallization of a substrate polymer in vacuum chambers or by depositing metal from a solution or from vapor onto the polymer surface. These processes can be carried out either on a film or on more rigid sheet products. Polymers commonly mirrorized include polymethyl methacrylate (PMMA), polycarbonate, polyethylene terephthalate (PET), polystyrene, and polyethylene terephthalate glycol (PETG), and combinations of the foregoing.

A second commonly employed method for preparing polymer mirrors is by producing a film with multiple very thin layers which, when placed in proximity to one another, behave as a mirror owing to the combination of refractive indices.

Heat lamination is a well known technique by which a laminating film is fused to a polymeric substrate but had not heretofore been used in the production of polymeric mirrors. For example, published International Patent Application WO/01/19591 A1 (to H. Ohanesian) disclosed a method and apparatus for the application of a decorative laminating film to a polymeric substrate. In that disclosure, a melted polymeric composition is forced through an extrusion die and is then laminated with a decorative film of 20 to 500 microns in thickness by applying pressure as the composition and laminating film passes through rollers, causing the decorative film and polymeric composition to fuse.

### SUMMARY OF THE INVENTION

The present invention applies heat lamination, which has henceforth been used to fuse layers of polymer sheet/film to the new use of producing a rigid polymer mirror.

In a first aspect of the invention, a method for producing a rigid high-reflectance mirror comprises the lamination of a polymeric substrate with a high-reflectance film that has been metallized by deposition of metal from vapor or plasma.

In a second aspect, the invention provides a method of producing a colored mirror by the application of a reflective multi-layer film whose combined refractive index causes the film to have the appearance of a colored mirror.

In a third aspect, the invention provides a method of producing a polymeric mirror having the appearance of a true silver mirror.

### DETAILED DESCRIPTION OF THE INVENTION

Before the present methods are described, it is to be understood that this invention is not limited to the particular methods, compositions, and experimental conditions described, as such methods may vary. It is also to be understood that the terminology used herein is for the purpose of describing particular embodiments only, and is not intended to be limiting, as the scope of the present invention is to be defined only by the appended claims.

Substrates suitable for use in the invention include any polymeric material such as acrylic from which a sheet product may be produced by calendering, including, but not limited to the following:

amorphous polyester resins (e.g. polymethylacrylate);

polyalkylene terephthalates (e.g polyethylene terephthalate, polybutylene

terephthalate, and poly-1,4-cyclohexanedimethylene terephthalate);

copolymers of polyalkylene terephthalate (e.g. copolymers of terephthalic acid or esters thereof with any of the following: i) napthalene dicarboxylic acid or esters thereof; ii) isophthalic acid or esters thereof; iii) phthalic acid or esters thereof; iv) alkane glycols; v) cycloalkane glycols; vi) alkane dicarboxylic acids; and vii) cycloalkane dicarboxylic acids; polyethylene napthalate (PEN) and isomers thereof; copolymers of polyethylene napthalate (PEN) including those of the (2,6-,1,4-, 1,5-, 2,7-, and/or 2,3- napthalene dicarboxylic acids, or esters thereof, with any of the following: i) napthalene dicarboxylic acid or esters thereof; ii) isophthalic acid or esters thereof; iii) phthalic acid or esters thereof; iv) alkane glycols; v) cycloalkane glycols; vi) alkane dicarboxylic acids; and vii) cycloalkane dicarboxylic acids;polycarbonate resins including acrylonitrile butadiene styrene resins, polystyrene, syndiotactic polystyrene, syndiotactic poly alpha-methyl styrene, syndiotactic polydichlorostyrene, copolymers and blends of the foregoing styrenes;styrene copolymers such as styrene butadiene copolymers and styrene acrylonitrile copolymers, 4,4′-bibenzoic acid and ethylene glycol; polyacrylates such as polybutylacrylate and polymethylacrylate;

polyimides such as polyacrylic imides and polyether imides; substituted and unsubstituted vinyl polymers and their copolymers; and other polymers processed by calendering including polyvinylchloride (PVC) as well as blends of two or more of the foregoing polymers or copolymers.

In a first embodiment of the invention, a polymeric film is first metallized and subsequently laminated by a calendering roll process to a rigid polymeric substrate as the substrate is extruded. Films suitable for metallization include PMMA, polycarbonate, PET, polystyrene, and polyethylene terephthalate glycol as well as mixtures and combinations thereof. Metallization of the film is typically accomplished either by depositing from plasma or vapor sputtering, such techniques being well known in the art. Preferably the thickness of the film before metallization is from about 0.002 inch to about 0.007 inch.

In a second embodiment of the invention, a reflective film composed of multiple very thin layers, which, owing to the combined index of refraction and thicknesses gives the appearance of a colored mirror, is bonded to the polymer substrate. In a particular embodiment, the reflective film may be composed of about 300 to about 400 layers and has a total thickness of about 0.002 inch to about 0.003 inch.

To improve adhesion to the acrylic or polymeric substrate, the reflective film, whether metallized or not, may be treated with an adhesion promoting coating (“a primer”) to further ensure bonding to the substrate. Application of such a primer is typically done by the manufacturer and its use is a known and accepted technique in lamination. However, when compatible polymer films are chosen for the substrate and the mirrorized film or colored film nearest the substrate, no adhesion promotor may be necessary.

### EXAMPLES

The following illustrative examples are presented so as to provide those of ordinary skill in the art with a complete disclosure and description of how to make and use the articles and methods of the invention.

A series of six films were applied to an acrylic sheet 2 mm in thickness by feeding the films over the second roll of a three or four roll calendar system into a melt pool. The melt pool was on the roll over which the film was run. Tension was applied to the film to remove and prevent the formation of wrinkles.

1. Mirrorized Film

The film used was a mirrorized polyethyleneterepthalate type material which had a heat activated adhesive applied by the manufacturer over the mirrorized surface. Film width was 24″.

2. Primed Color Mirror

This film had a PVdC primer applied by the manufacturer. The roll was 48″ wide. The film itself adheres to the sheet.

3. Polymeric Mirror Film

Results similar to film number 2 above.

4. High Temperature Polymeric Mirror Film

Results similar to film number 2 above.

What is claimed is:

1. A method for continuously preparing a sheet product having a mirror-like surface comprising:
(a) Continuously manufacturing a polymeric substrate;
(b) Applying a reflective film to said polymeric substrate as said polymeric substrate is manufactured to form a composite; and
(c) Continuously forming said composite by applying deformation heat and pressure using calendar rolls to produce a rigid final article having a reflective surface characterized by a mirror-like appearance.

2. The method of claim 1 wherein the reflective film has a first side and a second side, said first side being vacuum metalized and said first or second side optionally having a coating which facilitates adhesion to hot polymeric material applied thereon.

3. Method of claim 1 wherein the reflective film has at least two layers, which, when said layers are placed in proximity to one another, cause said film to have a mirror-like reflective appearance.

4. The method of claim 3 wherein a surface of said relective film which is not in continuous contact with another of said layers of the film has had a primer capable of promoting adhesion to said polymeric substrate applied thereto.

5. The method of claim 2 wherein the reflective film is comprised of a material selected from the group consisting of polyethylene terephthalate, polyethylene napthalate, PMMA, polycarbonate, and combinations thereof.

6. The method of claim 3 wherein the final article is a high-reflectance mirror.

7. The method of claim 3 wherein the final article is a colored mirror.

8. The method of claim 4 wherein the forming of the composite takes place at polymer melt temperature.

9. The method of claim 1 wherein the reflectance film has been metalized by causing metal to be deposited onto a surface of said reflective film from plasma.

10. The method of claim 1 wherein the reflectance film has been metalized by causing metal to be deposited onto a surface of said reflective film by sputtering from vapor.

11. The method of claim 1 wherein the polymeric substrate is selected from the group consisting of PMMA, polycarbonate, polyethylene terephthalate, polystyrene, and PETG.

12. The method of claim 1 wherein the polymeric substrate is an acrylic polymer.

13. The method of claim 1 wherein the reflective film has undergone coating to increase its scratch resistance or impart anti-static properties.
